(19) United States
(12) Patent Application Publication
(10) Pub. No.: US 2012/0305567 A1
(43) Pub. Date: Dec. 6, 2012

(54) Blast-attenuating container

(75) Inventor: David C. Abbe, El Cajon, CA (US)

(73) Assignee: AMERICAN INNOVATIONS, INC., Chestnut Ridge, NY (US)

(21) Appl. No.: 13/134,354

(22) Filed: Jun. 6, 2011

(51) Int. Cl. B65F 1/14; B65D 43/14; B65D 90/02

(52) U.S. Cl. 220/560.01; 220/23.87; 220/62.15; 220/810

(57) ABSTRACT

A blast-attenuating container for public spaces comprising an outer metallic shell enclosing a plurality of belted automobile tires, preferably used, in a stacked array, thereby defining a cylindrical central space for holding a removable waste receptacle. Within each tire is a water-filled energy-absorbing bladder. The stacked tires may be further enclosed by a fragmentation-absorbing reinforcing band. A cover over the shell has a hinged door for receiving and directing waste into the removable waste receptacle. The cover is removable for access to the waste receptacle. The can and waste receptacle may be provided with a load cell and programmed microprocessor for detecting the insertion of a possible threat item and an RF transmitter for sending an alert to a central security station.

### FIELD OF THE INVENTION

This invention relates to containers for public spaces such as parks, airports and train stations where there exists the possibility that a terrorist bomb may be placed in the container and explode without warning.

### BACKGROUND OF THE INVENTION

Waste containers are a necessity in all locations frequented by the public, such as parks, airports, train stations, stadiums and the like. It has long been recognized that such containers can be used by terrorists as hiding places for explosive devices.

The prior art has recognized different approaches to deal with this problem. In Europe, for example, public waste containers consist of relatively small transparent plastic bags suspended from posts and stanchions by thin metal loops, thus making their contents immediately visible to passers-by and security personnel, and tending to dissuade would-be terrorists. A more common but much more expensive approach has been to provide containers intended to withstand and safely absorb and/or harmlessly redirect the force of an explosion from a terrorist device. Such containers are typified by the following:

Holland, et al., U.S. Pat. No. 6,938,533 (Sep. 6, 2005) BLAST ATTENUATION CONTAINER, discloses a large domed outer container with access holes for the insertion of waste encloses a smaller open-topped receptacle which slides in and out through a hinged access door in the outer container. The outer container and inner receptacle are lined with a reinforced resin material which is said to be blast-resistant. The resulting device is large, complicated and difficult to construct and put in place.

Reynolds, U.S. Pat. No. 7,281,309 (Oct. 16, 2007) EXPLOSION RESISTANT WASTE CONTAINER discloses a double-layer open-topped steel shell with the inner space filled with poured-in reinforcing material, preferably reinforced concrete. The resulting device is also very heavy and difficult to install and reposition when required.

Sharpe et al., U.S. Pat. No. 7,342,843 (Mar. 18, 2008) EXPLOSIVE EFFECT MITIGATED CONTAINERS AND ENCLOSING DEVICES discloses a can-like container lined with two or more two flexible sheets or belts of inter-connected individual cells or modules, each containing a “shock-attenuating material” such as perlite and a “fusible salt” and “an optional anti-ballistic material”.

Waddell Jr., et al., 2007/0006723 (pub. Jan. 11, 2007) ACOUSTIC SHOCK WAVE ATTENUATING ASSEMBLY, like Sharpe et al., discloses bands of flexible armor-like material with encapsulated granular or porous attenuation material (perlite) in discrete modules, flexibly connected to wrap around a threat device enclosed in a container, or to protect an object from a external threat.

Warren, 2019/0300275 (pub. Dec. 2, 2010) APPARATUS FOR PROVIDING PROTECTION FROM BALLISTIC ROUNDS PROJECTILES, FRAGMENTS AND EXPLOSIVES discloses a multi-layer composite ceramic-plastic ballistic armor panel comprising a wire mesh matrix of a core, ceramic layer (spheres or beads), and bonding media (cast urethane), in combination with conventional sheet steel, for trash cans and other applications. See, also Warren, et al., 2011/0023693 (pub. Feb. 3, 2011) METHODS AND APPARATUS FOR PROVIDING BALLISTIC PROTECTION.

Eisenman et al., 2009/0019957 (pub. Jan. 22, 2009) METHOD AND SYSTEM FOR DETECTING BOMBS IN TRASH CANS discloses, in a general way, a system for detecting anomalous objects dropped into public area trash cans and transmitting a radio signal to a central watch station.

Holland, et al. ,U.S. Pat. No. 6,938,533 (Sep. 6, 2005) BLAST ATTENTUATION CONTAINER discloses a two-element trash can with a domed outer shell containing a smaller inner cylinder, with the cylinder being accessible via a side-opening door. The inner cylinder is to be provided with “blast suppression means” which can include a liquid (though no means of providing and holding the liquid is disclosed or suggested).

Donovan, U.S. Re. 36,912 (Oct. 7, 2000) METHOD AND APPARATUS FOR CONTAINING AND SUPPRESSING EXPLOSIVE DETONATIONS discloses the use of suspended plastic bags containing water for moderating the detonations of an enclosed explosion-hardening process.

All of the foregoing prior art pubic-space waste container designs suffer from significant disadvantages in complexity, weight, difficulty of installation, servicing and repositioning when necessary. None but the Donovan patent utilizes the considerable energy-absorbing properties of water, which due to its inherently high heat of vaporization can theoretically absorb much of the energy liberated by the detonation of commonly used high-order explosives such as C4 and TNT. (Black-powder type explosives explode by deflagration, not detonation, and thus release significantly less energy per unit weight.)

In terms of energy equivalence, 0.72 lb C4 is roughly equivalent 1.0 lb TNT, releasing about 1.9 million joules of energy on detonation. By contrast, the heat of vaporization of water is 2,260 joules per gram, or 1.0 million joules per lb of water. Thus one lb of water (a pint) is theoretically capable of absorbing the explosive energy of one-half lb of TNT. In a real-world situation the heat transfer physics are of course much more complicated, and there would not be a perfect one-to-one relationship between energy liberated and absorbed, but the underlying principle is still valid. Plain water is therefore an unappreciated and underutilized energy-absorbing medium for attenuating high-order explosive detonations, as well as being of obvious value in suppressing the flash and flame that follow.

Another important consideration in the manufacture of such a device is the use, if possible, of recycled materials. According to the USEPA, in 2003, the U.S.A. generated approximately 290 million scrap tires. While a substantial percentage of these scrap tires were re-utilized for fuel, civil engineering projects, or recycled into other products, still a substantial portion (27 million, or 9.3%) were destined to be disposed of in landfills, where they pose an environmental problem when stockpiled or illegally dumped, providing breeding grounds for mosquitoes and rodents.

A significant advantage of the present invention is that it uses and thereby recycles automotive tires in an environmentally valuable way. Even with most of its useful tread worn away, a typical modern automobile tire retains its principal structure with multiple plies of strong polymeric yarns and/or steel belting which are highly resistant to penetration not just by ordinary road hazards as originally intended, but also to rupture from the fragmentation of the kind of terrorist weapons that might be placed in a waste can in a public space.

It is therefore a principal object of the invention to provide an improved blast-attenuating container which is effective, economical to manufacture, and efficient in its use of labor and materials for production. Another object is to provide a container which efficiently utilizes otherwise wasted materials, in the present case worn-out automobile tires, for a useful purpose.

A further object is to provide such a device which can be easily assembled either at its place of manufacture, or transported in parts to its intended point of use where its various components, including recycled tires and water bladders, can be assembled. Similarly, by simply draining the water bladders and separating the tires, the device can be disassembled for storage or for transport to another location.

### SUMMARY OF THE INVENTION

The invention consists of a blast-attenuating container for public spaces comprising an outer metallic shell enclosing a plurality of belted automobile tires, preferably used, in a stacked array, thereby defining a cylindrical central space for holding a removable waste receptacle. Within each tire is a water-filled energy-absorbing bladder. The stacked tires may be further enclosed by a fragmentation-absorbing reinforcing band. A cover over the shell has a hinged door for receiving and directing waste into the removable waste receptacle. The cover is removable for access to the waste receptacle. The can and waste receptacle may be provided with a load cell and programmed microprocessor for detecting the insertion of a possible threat item and an RF transmitter for sending an alert to a central security station.

### BRIEF DESCRIPTION OF THE DRAWINGS

FIG. 1 is a perspective of a first embodiment of the improved waste can of the present invention in partial cutaway;

FIG. 2 is a cross-section in the plane 2-2 of the waste can of FIG. 1;

FIG. 3 is a detail view of water-filled bladders as inserted in the stacked tires of the device of FIGS. 1 and 2;

FIG. 4 is a perspective of a second embodiment of the invention in partial cutaway having a reinforcing band wrapped around the stacked tires; and

FIG. 5 is a cross-section in the plane 5-5 of the waste can of FIG. 3.

### DESCRIPTION OF THE PREFERRED EMBODIMENT

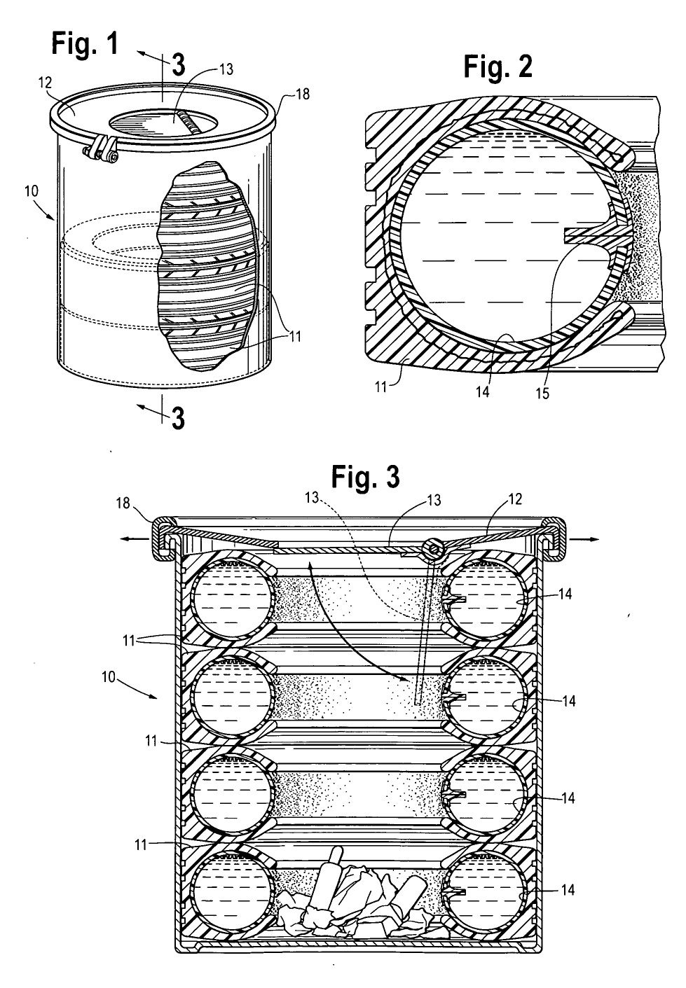

Turning to the drawings, in FIG. 1 there is shown in partial cutaway view a first embodiment of the container 10 of the present invention. The device is enclosed within a protective shell, preferably of steel or aluminum, which in the illustrated embodiment has a fixed bottom. Within the shell are placed several automobile tire belts 11 stacked vertically around a central axis. Alternatively, for ease of on-site assembly and disassembly, the shell may also be open-bottomed, allowing it to be placed over a pre-assembled stack of tires, and removed in the same way when the can is to be relocated.

The tires may be piled loosely as shown in FIG. 1, or more preferably may be secured to one another by fixing means such as, by way of example, metal clips, screws and nuts, rivets, wire or plastic ties, or gluing the adjoining edges together (not shown). To create a larger interior space for a removable waste receptacle, the beads of the tires 11 may be cut off, leaving only the belting and remaining tread. The outer diameter of the assembly may be further reduced by removing most of the remaining tread by grinding or other suitable means.

The shell is provided with a cover 12 which in the first illustrated embodiment is secured to the shell by a circumferential clamping ring 18. At the center of the cover 12 is an opening or entry port cooperating with the cylindrical internal space created by the stack of tires. Through this opening and into the cylindrical inner space is placed a removable central waste receptacle (not shown). The receptacle may be of any suitable material such as aluminum or plastic, and is sufficiently light and easy to handle that an attendant can easily lift it out for emptying and replacement. Alternatively, the cover may be provided with hooks or projections (not shown) from which a flexible plastic waste bag may be attached and suspended within the receptacle, or within the central internal space without the need of a rigid waste receptacle.

The cover is also desirably provided with a self-closing hinged door 13, utilizing either gravity or springs, for closing the entry port against the entry of birds or rodents, while permitting the public to easily place waste items into the can's inner receptacle. The door 13 is preferably made of lightweight plastic so as to be harmlessly blown free in the event of an explosion.

As a principal feature of the invention, water-filled toroidal bladders 14 are placed within at least some of the tires to provide a thermal buffer or sink for the absorption of the explosive energy of a detonation. For example, and not by way of limitation, the bladders can be actual automotive inner tubes filled through a valve 15 in the normal way with water instead of air. Alternatively, they can be fabricated like ordinary beach toys or air mattresses using sheet vinyl with heat-sealed seams and one-way filling valves. In addition, the mass of the bladders may be further increased by the addition of sand or the like.

A particular advantage of this embodiment and method of construction is that the waste can of the present invention can be transported in its disassembled component parts to the point of use, with the bladders 14 empty. For final assembly the bladders may be either partially or fully filled with water and inserted in the tires 11, and the tires then stacked together one atop the other, either with or without fixing means holding them together. The outer shell and cover 12 are then placed over the stack and the waste can is ready for use. Should it be necessary to move it to a new location, or put it in storage, the water can drained from the bladders entire device disassembled for later use.

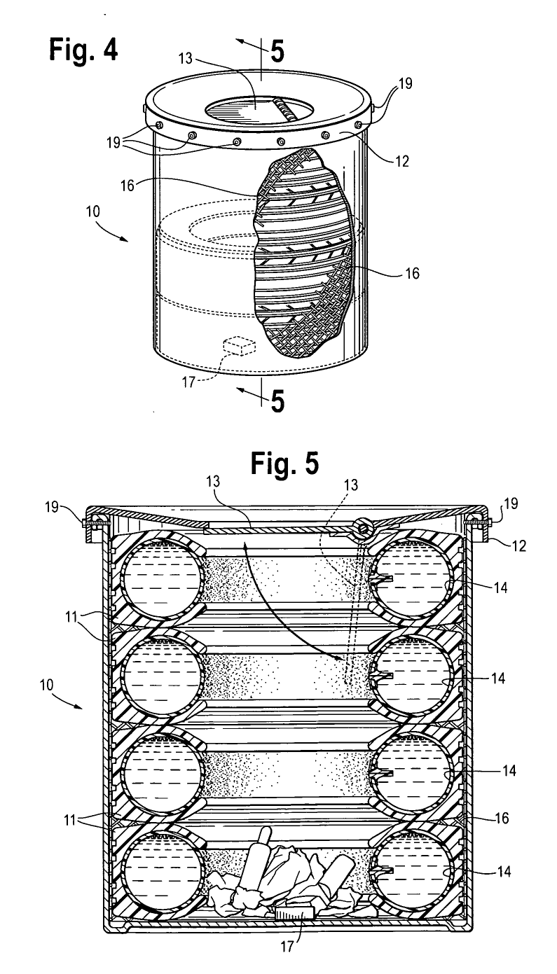

A second embodiment of the invention is shown in FIGS. 4 and 5. This embodiment differs from the embodiment of FIGS. 1 and 2 in that the lid 12 is attached to the can with screws 19 or other attachment means, and the stack of tires is held together by a surrounding circumferential reinforcing band 16. The reinforcing band 16 may be of any sufficiently strong material, such as filament-reinforced polymer such as industrial belting, chain-link metal mesh, or hardware cloth, wrapped around the stack of tires in one or more plies and secured by a suitable means such as plastic wrapping, as with industrial pallets. As illustrated in this embodiment, the shell is provided with a solid bottom which permits the device to be picked up and moved into place using, for example, a fork-lift truck or a dolly using wheels or casters. Because the bladders 14 can be filled with water and inserted later, the device is still relatively light and easy to move about, by contrast to the concrete-filled devices of the prior art.

As an additional useful feature of the invention, the can and waste receptacle may be provided with a load cell and self-powered programmed microprocessor 17 (FIGS. 4 and 5) for detecting the insertion of a possible threat item and an RF transmitter for sending an alert to a central security station (not shown). When the load cell detects an anomalous event, such as the deposit in the receptacle of an article exceeding a certain pre-programmed weight, it transmits a signal to the central security station, alerting authorities to the possibility of a threat device which needs to be immediately investigated and remediated, if required.

1. A blast-attenuating container comprising
(a) an outer shell,
(b) a plurality of automobile tire belts disposed in a stack around a vertical central axis within said outer shell and defining a hollow central enclosure, and
(c) water-filled energy-absorbing bladders inside at least some of said automobile tires.

2. The container of claim 1 including a removable receptacle contained within said hollow central enclosure.

3. The container of claim 1 in which said tire belts are used and thereby recycled.

4. The container of claim 1 further including a fragmentation-absorbing circumferential band interposed between said outer shell and said stack of tire belts.

5. The container of claim 4 in which said fragmentation-absorbing circumferential band is selected from the group including industrial belting, chain-link metal mesh, and hardware cloth.

6. The container of claim 1 in which at least some of said tires are secured together by anchoring means selected from the group including metal clips, screws and nuts, rivets, wire ties, plastic ties, and glueing.

7. The container of claim 1 including a cover having an entry port permitting the insertion of waste items into said removable waste receptacle.

8. The container of claim 7 in which said entry port includes a self-closing hinged door means for allowing insertion of waste materials into said removable waste receptacle.

9. The container of claim 1 in which said waste receptacle includes load cell and programmable microprocessor means for detecting the insertion of a suspected threat item, and RF transmitter means for communicating said threat in real-time to a central monitoring station.
